(19) United States
(12) Patent Application Publication
(10) Pub. No.: US 2016/0305187 A1
(43) Pub. Date: Oct. 20, 2016

(54) Traveling Earth Boring/Driling Device

(71) Applicant: John Edward Dorsch, Maumelle, AR (US)

(72) Inventor: John Edward Dorsch, Maumelle, AR (US)

(21) Appl. No.: 14/688,118

(22) Filed: Apr. 16, 2015

(51) Int. Cl. E21B 7/02; B60L 8/00

(52) U.S. Cl. CPC E21B 7/021; E21B 7/022; E21B 7/027; B60L 8/003

(57) ABSTRACT

The invention relates to an apparatus for producing a plurality of spaced apart drilled pits in the soil with excavated soil displaced radially outward to form an annular shape mound around the perimeter of the newly drilled pit. The earth boring/drilling device is a compact, portable and highly maneuverable power driven device which is self-propelled or towable.

The earth boring/drill device is arranged on a chassis with a plurality of upwardly depending support posts connected by horizontal support elements along with a mechanical means of reciprocating up and down a motorized power auger comprised of a shaft with a helical blade and cutting tips of hard wear-resistant material on the cutting end to drill a pit to a predetermined depth and predetermined diameter and then mound up excavated soil in an annular shape around the perimeter of the drilled pit as the auger is disengaged.

### CROSS-REFERENCE TO RELATED APPLICATIONS

This application claims benefit of provisional patent application Ser. No. 61/981,419, filed 2014 Apr. 18 by the present inventor.

### BACKGROUND OF THE INVENTION

### Field of the Invention

This invention relates to a farming device specific to drilling the soil in, but not limited to, sub-arid regions of the world where soil conditions are poor and water is scarce. It is a fact agricultural production in sub-arid climates face many obstacles such as poor encrusted soil, poor soil fertility, lack of water, high temperatures, and lack of equipment. Farming techniques such as Zai pit farming, is proven to increase crop production 500% if executed properly and can be implemented immediately. This technology fulfills three functions for encrusted soil conditions, for soil conservation, water conservation and erosion control. The concept is to plant crops in small pits enriched with compost and then concentrate the fertilizer and water to the plant roots in each pit. The harvested rainfall and any run-off water is captured in the pit to irrigate the plants and the pits also protect the young plants against wind erosion. This concentration of water and nutrients restores and enriches the soil to optimize soil biology for crop production. The process starts by digging pits approximately 20-40 cm in diameter by 10-20 cm deep and 60-100 cm apart depending on the crop. The excavated soil is mounded up around the newly dug pit. Approximately 0.06 grams of organic compost is added to each pit. After the first rainfall, organic compost is covered by the thin layer of soil with seeds placed in the middle of the pit. The excavated soil that was ridged around the pit in an annular shape improves water retention capacity in the pit. The advantages of pits are to capture rain water and surface water runoff, to protect seeds and organic matter from being washed away, to protect against wind erosion, to concentrate nutrient and water availability at beginning of rainy season and to increase crop yield and improve soil structure. The disadvantage of digging pits that the actual manual digging of pits is labor intensive. It is recorded to take between 300 to 450 hours per hectare for manually digging pits and mounding soil around the pit. Manually dug pits by nature may not maintain repeatability in consistent pit diameter, pit depth and pit spacing.

A method and apparatus for producing a plurality of sequentially spaced apart drilled spots in the soil are shown in U.S. Pat. No. 6,662,880 (2003) by Gedalhahu Manor. This device has a drilling shaft that rotates perpendicular to the ground in a circular motion and is powered by a tractor by means of a rotatable longitudinal axis shaft. The drilling shaft continually changes its angle relative to the soil from the point of entry, to vertical position, to the point of exit creating a pit with flared or trenched ends. The drilling shaft has a leading shank to penetrate ahead of the drill to assist and stabilize the drill as it rotates into the soil for initial penetration. The drilling shaft also has a lifting shank on the trailing side of the shaft which acts to pivot and stop further soil penetration and to start to rotate the drill out of the pit. The depth of the drilled pit is determined by the length of the drill. Although this apparatus does drill holes, the holes have trenched/flared ends that does not aid in total capture of rain water nor protect from run-off water as would the annular shaped mound of soil around the pit. This device will need the aid of a tractor and due to the size of the tractor and device, rows of drilled pits and pit proximity will depend on the width of the tractor and the width of the tractor wheel base along with the geometry of the rotating drill shaft to determine the number of rows and pits within the rows, all of which will be counterproductive in a small or large parcel of land. Also the cost of transporting, operating and general maintenance of the tractor and device will not be cost effective.

Still another method and apparatus for producing a plurality of sequentially spaced apart drilled spots in the soil are shown in U.S. Pat. No. 4,732,227 (1988) to Dan Wolf et. al. This device is for drilling rows of equidistant holes in the soil for trees and/or fence posts holes. A tractor pulls the device that is comprised of two augers that rotate about their axis. The holes are not cylindrical in shape due to the moment of the auger shaft continually changes its angle relative to the soil from the point of entry, to vertical position, to the point of exit creating a pit with flared or trenched ends. To facilitate entry of auger into hard soil, knives blades revolve together with the assembly to penetrate the soil prior to entry of augers and before their starting to drill the hole. The drilled depth is determined by the length of the auger shaft. Although this apparatus does drill holes, the holes have trenched, flared ends that does not aid into total capture of rain water nor protect from run-off water as would the annular shaped mound of excavated soil around the pit. As mentioned per U.S. Pat. No. 6,662,880 (2003) by Gedalhahu Manor, this device will need the aid of a tractor and due to the size of the tractor and device, rows of drilled pits and pit proximity will depend on the width of the tractor and the width of the tractor wheel base along with the geometry of the rotating drill shaft to determine the number of rows and pits within the rows. All of this will be counterproductive in a small or large parcel of land and the cost of transporting, operating and general maintenance of the tractor and device will not be cost effective.

A walk behind device is the Motorized Auger U.S. Pat. No. 6,056,065 by Campbell et al (2000). The motor is controlled by a throttle activating a chain driven wheel with an internal brake drum and internal brake shoes that are linked to a brake cable. The auger is mounted on a frame and is hydraulically driven. There are two sets of handles, one set of handles for driving the device and a second set of handles, on the opposite end of the device, to control the hydraulically operated auger. To use this device, one would drive and steer from one end of the device and then stop and pivot the motorized auger in the upright position and then walk around to the opposite end of the device, deploy stabilizing standoffs at the bottom to brace device and then engage and operate the hydraulically driven auger. All of this action will add more time to set up to use the device and then to break down to move to the next drilling site. Serviceability and maintenance on a lot of moving parts and hydraulics plus the inconvenience of changing positions when traveling and then operating the device will drastically increase time spent to use the device in the field drilling pits.

Pat. Appl. No. US2013/0042796 AI by Hoff (2013) relates to a drill comprised of multiple number of cutting knives and cutting elements which will need to be maintained periodically to bore partially tapered bore holes in the soil. The partially tapered bore holes have downwardly tapered sidewalls and a flat and horizontal bottom. The bore hole is refilled with soil, at least above the downward tapered sides, and plant boxes are positioned in the center of the bored holes to capture rainfall for the newly planted young plant. As the plant grows the plant box is removed. The device can be operated by electric, hydraulic or pneumatic drive actuation and also has a vibration element. The design of the frame has a frame within to balance the structure for drilling to keep the drill in a vertical position within the frame. Although this device is towable, the drilling stabilization is accomplished by plurality of support elements attached to the frame. To move this device will require a vehicle to tow it around a field and will require an enormous amount of time and effort for set up and break down. The number of spaced pits in a field will also decrease due to the design of the device and its support elements which, in a small field, will be counterproductive. One will need a tractor which will affect the number of drilled pits and planting rows because of tractor size and wheel base plus increases cost to operate and maintain. Speed, mobility and efficiency to set up, break down to move and repeat in a field to utilize this device will not be cost effective to operate in a small or even large field.

In conclusion in so far as I am aware, a device and method of planting does not exist which is a mobile, self-propelled or towable, mechanized traveling earth boring/drilling device developed to provide the ability to drill, with an auger comprised of a shaft with a helical blade with cutting tips of a hard wear-resistant material and is capable of drilling a plurality of cylindrical pits that direct and concentrate the flow of water and nutrients to the plant roots which are spaced apart in the soil. A device that drills the required depth and diameter pit and the ability to remove excavated soil by the auger as it reciprocates in an upward motion removing the soil radially and outwardly to form an annular shape mound around the excavated pit as the auger exits the soil and with an auger length sufficient to contact and penetrate the soil during each reciprocating cycle with consistent repeatable and maintainable function in a fraction of the time in comparison to manual effort to achieve the same results.

### BRIEF SUMMARY OF THE INVENTION

An improved method of digging pits preferably in a line for, but not limited to, the Zai pit method of farming with the use of a traveling earth boring/drilling device that is compact, portable, towable or self-powered and has a high degree of maneuverability. The earth boring/drilling device produces shallow drilled pits in soil with consistently uniform diameter and consistently uniform depth for soil preparation in encrusted impervious soil conditions. When rotating vertically and perpendicular to the plane of the soil, the auger shaft of the device, with its helical blade and cutting tips of hard wear-resistant material, is lowered down to penetrate the soil to create a drilled pit and then is raised up, with the rotating auger displacing the excavated soil radially and outward as it raises to form an annular shaped soil mound around the outside of the perimeter of the newly drilled pit.

This self-contained and self-propelled traveling earth boring/drilling device is comprised of a frame with a plurality of omnidirectional steerable power driven or free spinning wheels, a powered auger with a motor on one end and a shaft and a helical blade with cutting tips of hard wear-resistant material on the other end, and is able to penetrate and bore holes of a consistent size and depth. The earth boring/drilling device can straddle drilled pits with ability to create pits in the soil of patterns of successively spaced at predetermined distances apart which are calibrated by a wheel rotation measurement from the previous drilled pit location both in depth and location in a field prior to the planting of seeds or plants.

These drilled pits relate to conservation and preservation of moisture for growing vegetation in soil which is more or less impervious to water or difficult to percolate. The drilled pits will capture, contain and conserve rainfall and water runoff by the displaced excavated soil that mounds in an annular shape around freshly drilled pits. This will aid in stopping water erosion while also holding water and moisture within the pits and assist in containing any mixture of compost and fertilizer thereby putting nutrients back into the soil. The freshly drilled pits, with the annular shaped mound of excavated soil around each pit, will also serve to protect young plants from wind erosion. The soil conservation benefit of water harvesting, eliminating water erosion and eliminating wind erosion will improve land quality where land preforms its functions in a sustainable manor for land management and vegetation reestablishment to stop land degradation and desertification.

Use of the traveling earth boring/drilling device will help eliminate stress on the land to provide land recovery faster for existing land, rehabilitate abandoned land and reclaim new previously unfarmed land to produce crops for a growing population that is living longer while competing with increased numbers of grazing livestock. The earth boring/drilling device will decrease soil preparation time by mechanized means as compared to currently manual digging of pits. The device will provide repeatable uniform control and maintenance of consistent size and diameter of the drilled pits and create consistently uniform and repeatable annular mounds of displaced excavated soil around each pit. Each pit can be excavated in predetermined pattern that is calibrated by the wheel rotation measurement from the previously drilled pit location. Utilizing the earth boring/drilling device, on either a small parcel of land or a large farm, will save time and money when compared to the time and effort required to manually dig the pits which can also result in inconsistencies to the size and depth of the pits, and will also increase land sustainability farm practices while reducing desertification of the land.

### BRIEF DESCRIPTION OF THE SEVERAL VIEWS OF DRAWINGS

In the following drawings, which form part of the specification and which are to be construed in conjunction therewith, and in which like reference numbers have been employed throughout where possible to indicate like parts in various views:

FIG. 1 is a ¾ perspective view of the traveling earth boring/drilling device.

FIG. 2 is a right side cut away view of the traveling earth boring/drilling device with auger in the disengaged, raised position.

FIG. 3 is a right side cut away view of the traveling earth boring/drilling device with auger in the engaged, lowered position.

### DETAILED DESCRIPTION OF THE INVENTION

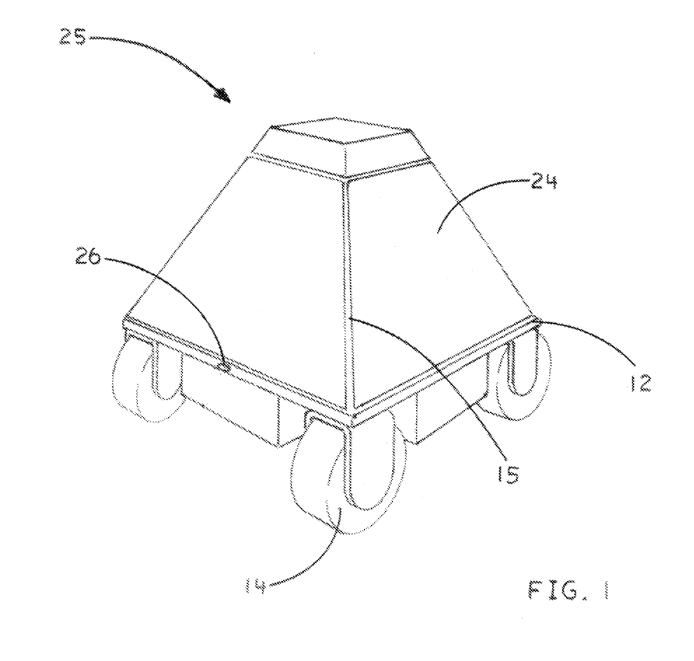

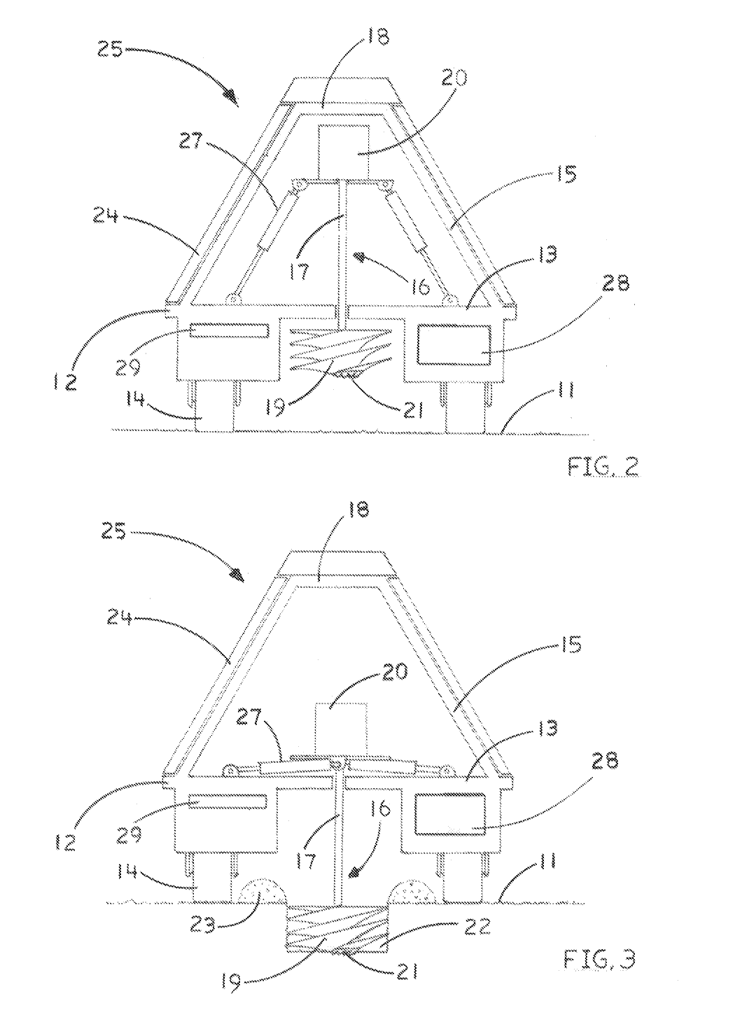

FIGS. 1, 2 and 3 illustrate the traveling earth boring/drilling device 25 designed to preform soil 11 preparation for planting. FIGS. 2 and 3 show internal components of the device 25. Device 25 is a balanced and stable design being provided with a chassis 13 having a compact rectangular frame 12 made from square steel tubing with upwardly depending support posts 15 connected by horizontal support elements 18. Within the device 25 is a powered reciprocating auger assembly 16 having a motor 20 on the upper end of a shaft 17 with a helical blade 19 having cutting tips 21 of a hard wear resistant material on the lower end of shaft 17. The powered reciprocating auger assembly 16 is reciprocally positioned between a disengaged up position, FIG. 2, and an engaged down position, FIG. 3, due to actuators 27 which connect the auger assembly 16 to the chassis 13. In the down position the auger 16 drills a predetermined diameter and predetermined depth pit 22 into the soil 11, FIG. 3. The chassis 13 has a plurality of omnidirectional steerable free spinning or power driven wheels 14 allowing multidirectional travel. The device 25 straddles the freshly drilled pit 22 with enough wheel base clearance and ground clearance so as not to come in contact with an annular shaped soil mound 23 of excavated soil 11 which is left around the top of the freshly drilled pit 22, FIG. 3. The chassis 13 contains a battery 28 to provide sufficient as needed power to motor 20 atop auger assembly 16 which powers actuators 27 to reciprocally position the auger assembly 16 between the raised and lowered position and also to power the omnidirectional wheels 14. Attached to chassis 13 is a plurality of solar panels 24, FIGS. 1, 2 and 3, to aid in recharging battery 28, FIGS. 2 and 3. Chassis 13 can also house an onboard computer 29 to give the device 25 a programmable autonomous operation capability.

### OPERATION

In operation one uses the traveling earth boring/drilling device 25 (FIGS. 1, 2, and 3) in a cleared parcel of land. When mechanically towed or controlled by the onboard computer 29, the device 25 systematically travels into position and drills a predetermined number of pits 22 within a boundary at a predetermined diameter and a predetermined depth. The device 25 travels into position by towing or self-propulsion and when stopped in a static position, the actuators 27 are engaged moving the auger assembly 16 in a downward motion with motor 20 causing the helical blade 19 to spin with blade 19 eventually contacting and penetrating the soil 11 thereby forming the pit 22 in soil 11, (FIGS. 2 and 3). When a predetermined depth is achieved, the actuators 27 automatically re-engage causing the auger assembly 16 to move in an upward motion with the rotating helical blade 19 dispersing the newly excavated soil 11, as it raises, radially outward to form an annular shaped mound 23 around the newly drilled pit 22 (FIG. 3). The auger assembly 16, in its most upward nested position (FIG. 2), provides enough clearance to not disturb the newly formed annular shaped excavated soil mounds 23 to which the device 25 then travels by towing or self-propulsion to the second predetermined distance that is calibrated on wheel 14 rotation measurement from the previous drilled pit 22 location, and then repeats the exact same drilling function as before. The size of the traveling earth boring/drilling device 25 enables it to be effective on small parcels of land or in large parcels of land at a reduction of the cost and time of manually preforming the drilling of the pits for planting.

The traveling earth boring/drilling device 25 has the onboard computer 29 into which a position determining system can be downloaded to accurately determine and control the position and movement of the device 25 when functioning in the autonomous, self-propulsion mode. Also a boundary detection system can be downloaded onto the onboard computer 29 to determine boundaries of the prepared parcel of ground for soil preparation when device 25 is operating in the autonomous, self-propelled mode. Another system that can be downloaded into the onboard computer 29 is a traffic collision avoidance system with camera 26, (FIG. 1), with picture identification software to identify stationary and moving objects to avoid collision that will be installed into the device 25 for functioning in the autonomous, self-propelled mode.

Additional systems that can be downloaded into the onboard computer 29 are self-diagnostic systems to monitor tasks/functions and can also recognize a problem in the operation of the traveling earth drilling/boring device 25 and shut it down if required and then alert the operator of the problem. A parameter/function setting capability system such as, but not limited to, environmental parameters (temperature, soil conditions, rain wind, etc.) and device parameters (run time, power consumption, etc.) can be installed into the onboard computer 29. Parameter functions can be programmable from an auxiliary input device which can also input parcel preparation data such as route information, drilling depth, etc., that can be stored in the onboard computer 29 memory.

The traveling earth boring/drilling device 25 can be operated by means of being towed mechanically by a vehicle when not being operated in the autonomous or self-propelled mode. In addition, the traveling earth boring/drilling device 25 can be transported by means of a vehicle towing a trailer. The simplistic design of the device 25 maximizes the use of common parts throughout to efficiently maintain or replace components in the field when necessary with minimal downtime.

After the parcel of land has the predetermined number of drilled pits, the farmer then adds fertilizer, soil and seed to each pit. Drip irrigation and fertigation can be used with each drilled pit to maximize yield where available to achieve maximum harvesting results.

What is claimed is:

1. A traveling earth boring/drilling device for drilling a plurality of holes in the soil of a predetermined diameter and predetermined depth, as in but not limited to, the Zai pit farming method said device comprising:
A four sided frame having upward support elements and horizontal support elements mounted upon a chassis, said chassis connected to pivotal free spinning or powered wheels which allow for multi-directional travel of said device, said four sided frame clad by panels, solar panels or the like, on all four sides affixed to said upward support elements creating an enclosure for said device.

2. A traveling earth boring/drilling device as in claim 1, whereas said enclosure of said device houses a powered reciprocating auger assembly, said auger assembly affixed centrally to said four sided frame with said auger assembly disposed in a vertical orientation within said enclosure, said powered reciprocating auger assembly comprising:
A drive motor, a shaft and a helical shape cutting blade, said drive motor affixed to said shaft at the top, uppermost end, said helical shape cutting blade affixed to said shaft on the lower, bottom end, said helical shape cutting blade having hardened cutting tips at lower edge of said blade, said auger assembly selectively disposable between a raised, disengaged position and a lowered engaged position,
said drive motor of said auger assembly powering said shaft rotating said helical cutting blade horizontally about the axis of said shaft as said auger assembly cycles between said disengaged position and said engaged position.

3. A traveling earth boring/drilling device as in claim 2, whereas said auger assembly is mechanically affixed to a series of powered actuators which act upon and cycle said auger assembly in a vertical line of travel, between said raised, disengaged position and said lowered engaged position:
said auger assembly, lowering to said engaged position, reaches a point at which said cutting blade comes into contact with said soil and initial contact with said soil is made with said hardened cutting tips of said helical blade which bores said pit to said predetermined depth and diameter, said auger assembly, upon boring said pit to said predetermined depth, then automatically raises upward to assume said disengaged position with said cutting blade extracting said soil as it travels upward from said pit and said helical shaped cutting blade depositing said soil radially and outward as it raises forming an annular ring of said soil of uniform height about the top perimeter of said pit.

4. A traveling earth boring/drilling device as in claim 1, whereas said device can be operated
towed behind a vehicle such as a tractor or the like but may also be operated in an autonomous, self-propelled mode, said self-propelled mode powered by rechargeable batteries housed within said chassis of said device, said battery supplying power to said powered wheels to position said device to bore said pits and also powers said motor of said auger assembly.

5. A traveling earth boring/drilling device as in claim 4, whereas said device is controlled by an onboard computer when being operated in said autonomous, self-propelled mode, said computer housed within said chassis, said computer also correctly positioning said device.
